(19) United States
(12) Patent Application Publication
(10) Pub. No.: US 2025/0234856 A1
(43) Pub. Date: Jul. 24, 2025

(54) ADIPOSE TISSUE TRANSPORT PRESERVATION SOLUTION

(71) Applicant: WUXI CELLULAR BIOPHARMACEUTICAL GROUP LTD., Wuxi, Jiangsu (CN)

(72) Inventors: Shuangquan CHEN, Wuxi, Jiangsu (CN); Dong XU, Wuxi, Jiangsu (CN)

(73) Assignee: WUXI CELLULAR BIOPHARMACEUTICAL GROUP LTD., Wuxi, Jiangsu (CN)

(21) Appl. No.: 18/697,849

(22) PCT Filed: Oct. 13, 2022
(86) PCT No.: PCT/CN2022/125132

§ 371 Date: Apr. 2, 2024

(30) Foreign Application Priority Data
Oct. 13, 2021 (CN) 202111193608.7

(51) Int. Cl. A01N 1/126; A01N 1/124

(52) U.S. Cl. CPC A01N 1/126; A01N 1/124

(57) ABSTRACT

Provided is an adipose tissue transport preservation solution. Specifically, the transport preservation solution includes: (a) 60-90 parts by weight of DMEM, high glucose and phenol red-free; (b) 10-30 parts by weight of DMEM/F-12, HEPES and phenol red-free; (c) 50-200 ng/mL of a bactericide; and (d) 2-10 mmol/L of L-glutamine. Adipose tissue can be transported and preserved by the preservation solution at a low temperature of 2-8° C. for 72 h or more.

### TECHNICAL FIELD

The present invention relates to the technical field of biology. Specifically, the present invention relates to a transport preservation solution for preserving adipose tissue at low temperature for a long time.

### BACKGROUND

Adipose tissue has been regarded as an endocrine organ due to effects in energy regulation, inflammatory response, and immune response. In addition, the adipose tissue is also a source of pluripotent cells with multidirectional differentiation potential, and the pluripotent cells are found in a stromal vascular fraction of the adipose tissue. The stromal vascular fraction (SVF) in the adipose tissue is obtained after subjecting the adipose tissue to digestion with collagenase, filtration, and centrifugation to remove mature adipose cells. The SVF is easily extracted from the adipose tissue, and contains abundant adipose tissue-derived mesenchymal stem cells (ASC) with strong plasticity.

It has been reported that the SVF derived from human breast and visceral adipose tissue contains endothelial cells, non-characteristic stromal cells, blood cells, and tissue macrophages. In addition, the SVF is also a source of hematopoietic progenitor cells and mesodermal stem cells (that can be differentiated into osteogenic, chondrogenic, myogenic, and neurogenic cell lines). The SVF can promote regeneration, formation and induced differentiation of blood vessels, and the survival rate of adipose can be improved by injection of autologous purified live cells of the SVF.

Fresh adipose tissue samples can ensure that the extracted mesenchymal stem cells have good biological activity, cell properties and proliferation ability. However, as a sample collection site (such as a hospital) and a sample production site are usually located in different places, the adipose tissue samples need to be preserved in a transport preservation solution after collection, and transported to the production site in a certain temperature environment for preservation and production.

Regarding preservation of the adipose tissue samples, the adipose tissue samples are generally preserved at room temperature for no more than 24 h, or rewarmed after cryopreservation, but dry ice or liquid nitrogen is usually used to maintain cell freezing during cryogenic freezing transport. Although the cell activity can be maintained for a long time, requirements for transport conditions are very strict, and a high transport cost is caused, so that wide use in practical application is difficult. However, low temperature (0-10° C.) treatment can reduce oxygen free radicals and lipid peroxides produced in a normal physiological process of cells without special treatment of the transported samples (ready-to-use). Moreover, low temperature transport is very cheap compared with freezing transport.

Therefore, it is urgent to develop a low temperature transport preservation solution for adipose tissue with a long preservation time and a good preservation effect in the field.

### SUMMARY

The purpose of the present invention is to provide a preservation solution (such as a low temperature transport preservation solution for adipose tissue) with a long tissue or cell preservation time and a good preservation effect.

In a first aspect, the present invention provides a preservation solution (such as an adipose tissue transport preservation solution), which includes:
(a) preferably, 60-90 parts by weight of a first medium (such as DMEM, high glucose and phenol red-free);
(b) preferably, 10-30 parts by weight of a second medium (such as DMEM/F-12, HEPES and phenol red-free);
(c) preferably, 50-200 ng/mL of a bactericide or an antibiotic; and
(d) preferably, 2-10 mmol/L of glutamine (such as L-glutamine).

In another preferred embodiment, in the preservation solution, the components (a)-(d) account for 80-100 wt % of a total weight of the preservation solution, preferably 85-99 wt %, and more preferably 95-98.5 wt %.

In another preferred embodiment, in the preservation solution, a weight ratio of the component (a) to the component (b) is (3.5-4.5):1, preferably (3.8-4.2):1. The weight ratio of the component (a) to the component (b) may be about 10:1 to about 1:5, about 8:1 to about 1:3, about 6:1 to about 1:2, about 5:1 to about 1:1, about 5:1 to about 2:1, about 5:1 to about 3:1, or about 5:1 to about 4:1. The weight ratio of the component (a) to the component (b) may be about 10:1, about 9:1, about 8:1, about 7:1, about 6.5:1, about 6:1, about 5.5:1, about 5:1, about 4.5:1, about 4:1, about 3.5:1, about 3:1, about 2.5:1, about 2:1, about 1.5:1, or about 1:1.

In another preferred embodiment, the component (a) accounts for 70-85 parts by weight, preferably 75-82 parts by weight.

In another preferred embodiment, the component (b) accounts for 15-25 parts by weight, preferably 18-22 parts by weight.

In another preferred embodiment, the concentration of the component (c) is 80-120 ng/mL, preferably 90-110 ng/mL, and more preferably 95-105 ng/mL.

In another preferred embodiment, the concentration of the component (d) is 3-6 mmol/L, preferably 3.5-4.5 mmol/L.

In another preferred embodiment, the bactericide is gentamicin (such as gentamicin sulfate or a gentamicin sulfate injection).

Non-restrictive examples of the antibiotic include penicillins (such as flucloxacillin, amoxicillin, ampicillin, carbenicillin, mezlocillin, and penicillin), cephalosporins (such as cefazolin, cefuroxime, cefotaxime, cefaclor, cephalexin, and cefepime), β-lactamase inhibitors (such as sulbactam and tazobactam), tetracycline (such as doxycycline, minocycline, tetracycline, and oxytetracycline), aminoglycosides (such as gentamicin, neomycin, streptomycin, and kanamycin), macrolide antibiotics (such as azithromycin, clarithromycin, erythromycin, roxithromycin, spiramycin, and clindamycin), lincosamides (such as lincomycin), gyrase inhibitors (such as ciprofloxacin, ofloxacin, and norfloxacin), sulfonamides (such as bactrim), trimethoprim, glycopeptides (such as vancomycin), polypeptide antibiotics (such as colistin and polymyxin), carbapenems (such as meropenem); quinolines (such as levofloxacin); carbacephems; cephamycins; monocyclic β-lactams; quinolones; macrolides; fluoroquinolones; and amphenicole (such as chloramphenicol). In one embodiment, the antibiotic is an antisense antibiotic oligomer.

The non-restrictive examples of the antibiotic further include amoxicillin, tetracycline, metronidazole, rifabutin, clarithromycin, clofazimine, vancomycin, rifampicin, nitroimidazole, chloramphenicol and combinations thereof. In some aspects, the antibiotic may be selected from rifaximin, rifamycin derivatives, rifampicin, rifabutin, rifapentine, rifalazil, bicozamycin, aminoglycosides, gentamicin, neomycin, streptomycin, paromomycin, verdamicin, mutamycin, sisomicin, netilmicin, retymicin, kanamycin, aztreonam, aztreonam macrolide, clarithromycin, dirithromycin, roxithromycin, telithromycin, azithromycin, bismuth subsalicylate, vancomycin, fidaxomicin, amikacin, arbekacin, rhodostreptomycin, tobramycin, apramycin, daptomycin, and combinations thereof.

In another preferred embodiment, in the preservation solution, a balanced amount of water is included in addition to the components (a)-(d).

In another preferred embodiment, in the preservation solution, the water accounts for 0-20 wt % of the total weight of the preservation solution, preferably 1-5 wt %.

In a second aspect, the present invention provides a method for preserving tissue or cells (such as preserving adipose tissue in a transport process). The method includes the following step: preserving tissue or cells (such as adipose tissue) in the preservation solution as described in the first aspect of the present invention at 2-8° C.

In another preferred embodiment, the preserving is performed at a temperature of 4-6° C.

In another preferred embodiment, the preserving is performed at 3.5-4.5° C.

In another preferred embodiment, the preserving is performed for 0.1-84 h.

In another preferred embodiment, the preserving is performed for 24-75 h.

In another preferred embodiment, the preserving is performed for 48-72 h.

In another preferred embodiment, the preserving is performed for 64-72 h.

In another preferred embodiment, a volume ratio of the tissue or cells (such as adipose tissue) to the preservation solution in the preserving is (1-2):(1-2); preferably (1-1.5):1.

In a third aspect, the present invention provides a preparation method for the preservation solution as described in the first aspect of the present invention. The preparation method includes the following step: uniformly mixing the components (a), (b), (c), and (d) at a ratio to obtain the preservation solution.

It is to be understood that, within the scope of the present invention, the above technical features of the present invention and technical features specifically described below (such as examples) can be combined with each other to form new or preferred technical solutions. Due to limited space, details are not described herein.

### DETAILED DESCRIPTION OF THE EMBODIMENTS

After extensive and in-depth research, the inventor provides a preservation solution through a large number of screening and testing. In the present invention, through compounding of specific components, a sample can be transported and preserved in a transport solution at 2-8° C. for 72 h or more without affecting an extraction rate of SVF cells. On this basis, the present invention is completed.

### Terms

Unless otherwise defined, all technical terms and scientific terms used herein have the same meanings as those generally understood by persons of ordinary skill in the field to which the present invention belongs.

It should be understood that, although not always explicitly stated, all numeric names can be preceded by the term “about”. In the case that a specific value is described in the present application and claims, it should be assumed that the term “about” means an acceptable error range of the specific value, unless otherwise specified. As used herein, the term “about” refers to a specific value±10%.

Alternatively, when used in reference to specifically listed values, the term “about” means that the value may vary not more than 1% from the listed values. For example, as used herein, the statement “about 100” includes all values between 99 and 101 (such as 99.1, 99.2, 99.3, 99.4, and the like).

As used herein, the terms “contain” or “include (comprise)” may be open, semi-closed and closed. In other words, the term also includes “basically consist of . . . ”, or “consist of . . . ”.

As used herein, the term “room temperature” or “normal temperature” refers to a temperature of 4-40° C., preferably 25±5° C.

### Transport Preservation Solution

Compared with standing preservation, adipose tissue is partially immersed in a preservation solution as the adipose tissue and the transport preservation solution are fully mixed by shaking in a transport process of the adipose tissue. However, during long-term standing preservation, the adipose tissue gradually floats and infiltrates an upper layer of the preservation solution due to a low density. Therefore, the adipose tissue has different environmental conditions during transport (such as effect of shaking on temperature, oxygen, impact, and other factors) from those during standing, and higher requirements for the preservation solution used during transport are put forward.

In addition, another barrier in preservation and transport of the adipose tissue is that after adipose cells are in vitro, the tissue needs to stay in a sterile state in a whole preparation and culture process for subsequent culture and application. Moreover, while maintaining the adipose tissue in a sterile state, it is also necessary to ensure the cell activity of the tissue.

The present invention provides a preservation solution (such as an adipose tissue transport preservation solution), which includes:
(a) preferably, 60-90 parts by weight of a first medium (such as DMEM, high glucose and phenol red-free);
(b) preferably, 10-30 parts by weight of a second medium (such as DMEM/F-12, HEPES and phenol red-free);
(c) preferably, 50-200 ng/mL of a bactericide or an antibiotic; and
(d) preferably, 2-10 mmol/L of L-glutamine.

The concentration of the components (c) and (d) is the final concentration in the transport preservation solution, which is calculated based on a total volume (weight) of the preservation solution.

Preferably, in the transport preservation solution, the components (a)-(d) account for 80-100 wt % of the total weight of the preservation solution, preferably 85-99 wt %, and more preferably 95-98.5 wt %.

Preferably, the bactericide is gentamicin sulfate.

In addition, the transport preservation solution may also include a certain amount of water, such as 1-5 wt of water. The water may be introduced by dissolving the L-glutamine and/or the bactericide in a preparation process without obviously affecting properties of the preservation solution of the present invention.

The first medium (or the second medium) may include DMEM, DMEM/F12, RPMI1640, AIM-V, MEM, α-MEM, F-12, X-Vivo 15, X-Vivo 20, Optimizer and the like.

The composition of the component (a), “DMEM, high glucose and phenol red-free”, is known to persons skilled in the art, and may be commercially purchased or prepared. For example, the DMEM refers to Dulbecco's Modified Eagle's Medium, the “high glucose” refers to glucose with a concentration of about 4,500 mg/L, and the “phenol red-free” refers to no phenol red.

In some embodiments, the preservation composition (or component (a)) of the present invention includes (or basically consists of, or consists of) all of ingredients listed in Table 1. In some embodiments, the preservation composition (or component (a)) of the present invention includes (or basically consists of, or consists of) 30, 29, 28, 27, 26, 25, 24, 23, 22, 21, 20, 19, 18, 17, 16, 15, 14, 13, 12, 11, 10, 9, 8, 7, 6, 5, 4, or 3 of the ingredients listed in Table 1.

In some embodiments, the preservation composition (or component (a)) of the present invention includes (or basically consists of, or consists of) all of amino acids listed in Table 1. In some embodiments, the preservation composition (or component (a)) of the present invention includes (or basically consists of, or consists of) 14, 13, 12, 11, 10, 9, 8, 7, 6, 5, 4, 3, 2, 1, or 0 of the amino acids listed in Table 1.

In some embodiments, the preservation composition (or component (a)) of the present invention includes (or basically consists of, or consists of) all of vitamins listed in Table 1. In some embodiments, the preservation composition (or component (a)) of the present invention includes (or basically consists of, or consists of) 8, 7, 6, 5, 4, 3, 2, 1, or 0 of the vitamins listed in Table 1.

In some embodiments, the preservation composition (or component (a)) of the present invention includes (or basically consists of, or consists of) all of inorganic salts listed in Table 1.

In some embodiments, the preservation composition (or component (a)) of the present invention includes (or basically consists of, or consists of) 7, 6, 5, 4, 3, 2, 1, or 0 of the inorganic salts listed in Table 1.

In some embodiments, the concentration of the ingredients in the preservation composition (or component (a)) of the present invention may be about a concentration as shown in Table 1 (mg/L or mM). In some embodiments, the concentration of the ingredients in the preservation composition (or component (a)) of the present invention may be a specific value (concentration in Table 1)±30%, a specific value (concentration in Table 1)±25%, a specific value (concentration in Table 1)±20%, a specific value (concentration in Table 1)±15%, a specific value (concentration in Table 1)±10%, or a specific value (concentration in Table 1)±5%.

TABLE 1

| | | |
|---|---|---|
| | Concentration | Concentration |
| Ingredient | (mg/L) | (mM) |

Amino acid

| | | |
|---|---|---|
| Glycine | 30.0 | 0.4 |
| L-arginine hydrochloride | 84.0 | 0.39810428 |
| L-cystine 2HCl | 63.0 | 0.20127796 |
| L-histidine hydrochloride-H₂O | 42.0 | 0.2 |
| L-isoleucine | 105.0 | 0.8015267 |
| L-leucine | 105.0 | 0.8015267 |
| L-lysine hydrochloride | 146.0 | 0.7978142 |
| L-methionine | 30.0 | 0.20134228 |
| L-phenylalanine | 66.0 | 0.4 |
| L-serine | 42.0 | 0.4 |
| L-threonine | 95.0 | 0.79831934 |
| L-tryptophan | 16.0 | 0.078431375 |
| L-tyrosine disodium salt dihydrate | 104.0 | 0.39846742 |
| L-valine | 94.0 | 0.8034188 |

Vitamin

| | | |
|---|---|---|
| Choline chloride | 4.0 | 0.028571429 |
| D-calcium pantothenate | 4.0 | 0.008385744 |
| Folic acid | 4.0 | 0.009070295 |
| Nicotinamide | 4.0 | 0.032786883 |
| Pyridoxine hydrochloride | 4.0 | 0.019417476 |
| Riboflavin | 0.4 | 0.0010638298 |
| Thiamine hydrochloride | 4.0 | 0.011869436 |
| I-inositol | 7.2 | 0.04 |

Inorganic salt

| | | |
|---|---|---|
| Calcium chloride | 200.0 | 1.8018018 |
| (CaCl₂) (anhydrous) | | |
| Ferric nitrate | 0.1 | 2.4752476E−4 |
| (Fe(NO₃)₃•9H₂O) | | |
| Magnesium sulfate (MgSO₄) | 97.67 | 0.8139166 |
| (anhydrous) | | |
| Potassium chloride (KCl) | 400.0 | 5.3333335 |
| Sodium bicarbonate (NaHCO₃) | 3700.0 | 44.04762 |
| Sodium chloride (NaCl) | 6400.0 | 110.344826 |
| Sodium dihydrogen phosphate | 125.0 | 0.9057971 |
| (NaH₂PO₄•H₂O) | | |

Other ingredient

| | | |
|---|---|---|
| D-glucose (dextrose) | 4500.0 | 25.0 |

Similarly, the composition of the component (b), “DMEM/F-12, HEPES and phenol red-free”, is known to persons skilled in the art, and may be commercially purchased or prepared. The HEPES refers to 4-(2-hydroxyethyl)-1-piperazine ethanesulfonic acid.

In some embodiments, the preservation composition (or component (b)) of the present invention includes (or basically consists of, or consists of) all of ingredients listed in Table 2. In some embodiments, the preservation composition (or component (b)) of the present invention includes (or basically consists of, or consists of) 51, 50, 49, 48, 47, 46, 45, 44, 43, 42, 41, 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, or 3 of the ingredients listed in Table 2.

In some embodiments, the preservation composition (or component (b)) of the present invention includes (or basically consists of, or consists of) all of amino acids listed in Table 2. In some embodiments, the preservation composition (or component (b)) of the present invention includes (or basically consists of, or consists of) 21, 20, 19, 18, 17, 16, 15, 14, 13, 12, 11, 10, 9, 8, 7, 6, 5, 4, 3, 2, 1, or 0 of the amino acids listed in Table 2.

In some embodiments, the preservation composition (or component (b)) of the present invention includes (or basically consists of, or consists of) all of vitamins listed in Table 2. In some embodiments, the preservation composition (or component (b)) of the present invention includes (or basically consists of, or consists of) 10, 9, 8, 7, 6, 5, 4, 3, 2, 1, or 0 of the vitamins listed in Table 2.

In some embodiments, the preservation composition (or component (b)) of the present invention includes (or basically consists of, or consists of) all of inorganic salts listed in Table 2.

In some embodiments, the preservation composition (or component (b)) of the present invention includes (or basically consists of, or consists of) 12, 11, 10, 9, 8, 7, 6, 5, 4, 3, 2, 1, or 0 of the inorganic salts listed in Table 2.

In some embodiments, the preservation composition (or component (b)) of the present invention includes (or basically consists of, or consists of) all of “other ingredients” (D-glucose, HEPES, hypoxanthine sodium, linoleic acid, lipoic acid, putrescine 2HCL, sodium pyruvate and thymidine) listed in Table 2. In some embodiments, the preservation composition (or component (b)) of the present invention includes (or basically consists of, or consists of): 8, 7, 6, 5, 4, 3, 2, 1, or 0 of the “other ingredients” (D-glucose, HEPES, hypoxanthine sodium, linoleic acid, lipoic acid, putrescine 2HCL, sodium pyruvate and thymidine) listed in Table 2.

In some embodiments, the concentration of the ingredients in the preservation composition (or component (b)) of the present invention may be about a concentration as shown in Table 2 (mg/L or mM). In some embodiments, the concentration of the ingredients in the preservation composition (or component (b)) of the present invention may be a specific value (concentration in Table 2)±30%, a specific value (concentration in Table 2)±25%, a specific value (concentration in Table 2)±20%, a specific value (concentration in Table 2)±15%, a specific value (concentration in Table 2)±10%, or a specific value (concentration in Table 2)±5%.

TABLE 2

| | | |
|---|---|---|
| Ingredient | Concentration (mg/L) | Concentration (mM) |

Amino acid

| | | |
|---|---|---|
| Glycine | 18.75 | 0.25 |
| L-alanine | 4.45 | 0.049999997 |
| L-arginine hydrochloride | 147.5 | 0.69905216 |
| L-asparagine-H₂O | 7.5 | 0.05 |
| L-aspartic acid | 6.65 | 0.05 |
| L-cysteine hydrochloride-H₂O | 17.56 | 0.09977272 |
| L-cystine 2HCl | 31.29 | 0.09996805 |
| L-glutamic acid | 7.35 | 0.05 |
| L-glutamine | 365.0 | 2.5 |
| L-histidine hydrochloride-H₂O | 31.48 | 0.14990476 |
| L-isoleucine | 54.47 | 0.41580153 |
| L-leucine | 59.05 | 0.45076334 |
| L-lysine hydrochloride | 91.25 | 0.4986339 |
| L-methionine | 17.24 | 0.11570469 |
| L-phenylalanine | 35.48 | 0.2150303 |
| L-proline | 17.25 | 0.15 |
| L-serine | 26.25 | 0.25 |
| L-threonine | 53.45 | 0.44915968 |
| L-tryptophan | 9.02 | 0.04421569 |
| L-tyrosine disodium salt dihydrate | 55.79 | 0.21375479 |
| L-valine | 52.85 | 0.4517094 |

Vitamin

| | | |
|---|---|---|
| Biotin | 0.0035 | 1.4344263E−5 |
| Choline chloride | 8.98 | 0.06414285 |
| D-calcium pantothenate | 2.24 | 0.0046960167 |
| Folic acid | 2.65 | 0.0060090707 |
| Nicotinamide | 2.02 | 0.016557377 |
| Pyridoxine hydrochloride | 2.0 | 0.009708738 |
| Riboflavin | 0.219 | 5.824468E−4 |
| Thiamine hydrochloride | 2.17 | 0.0064391694 |
| Vitamin B12 | 0.68 | 5.0184503E−4 |
| I-inositol | 12.6 | 0.07 |

Inorganic salt

| | | |
|---|---|---|
| Calcium chloride (CaCl₂) (anhydrous) | 116.6 | 1.0504504 |
| Copper sulfate (CuSO₄•5H₂O) | 0.0013 | 5.2E−6 |
| Ferric nitrate (Fe(NO₃)₃•9H₂O) | 0.05 | 1.2376238E−4 |
| Ferrous sulfate (FeSO₄•7H₂O) | 0.417 | 0.0015 |
| Magnesium chloride (anhydrous) | 28.64 | 0.30147368 |
| Magnesium sulfate (MgSO₄) (anhydrous) | 48.84 | 0.407 |
| Potassium chloride (KCl) | 311.8 | 4.1573334 |
| Sodium bicarbonate (NaHCO₃) | 1200.0 | 14.285714 |
| Sodium chloride (NaCl) | 6995.5 | 120.61207 |
| Anhydrous disodium hydrogen | 71.02 | 0.50014085 |
| phosphate (Na₂HPO₄) | | |
| Sodium dihydrogen phosphate | 62.5 | 0.45289856 |
| (NaH₂PO₄•H₂O) | | |
| Zinc sulfate (ZnSO₄•7H₂O) | 0.432 | 0.0015 |

Other ingredient

| | | |
|---|---|---|
| D-glucose (dextrose) | 3151.0 | 17.505556 |
| HEPES | 3574.5 | 15.018908 |
| Hypoxanthine sodium | 2.39 | 0.015031448 |
| Linoleic acid | 0.042 | 1.4999999E−4 |
| Lipoic acid | 0.105 | 5.097087E−4 |
| Putrescine 2HCl | 0.081 | 5.031056E−4 |
| Sodium pyruvate | 55.0 | 0.5 |
| Thymidine | 0.365 | 0.0015082645 |

### Preparation Method

A preparation method for the preservation solution (such as a tissue transport preservation solution) of the present invention may include the following step: uniformly mixing the components (a), (b), (c), and (d) at a ratio to obtain the preservation solution.

Typically, the components (a) and (b) are mixed first, and then the components (c) (such as an aqueous solution) and (d) are added and mixed.

### Method for Preserving Adipose Tissue in a Transport Process

Further, the present invention also provides a method for preserving tissue or cells (such as preserving adipose tissue in a transport process). The method includes the following step: preserving tissue or cells (such as adipose tissue) in the preservation solution as described above at 2-8° C.

In another preferred embodiment, the preserving is performed at a temperature of 4-6° C.

In another preferred embodiment, the preserving is performed at 3.5-4.5° C.

In another preferred embodiment, the preserving is performed for 0.1-84 h.

In another preferred embodiment, the preserving is performed for 24-72 h.

In another preferred embodiment, the preserving is performed for 48-72 h.

In another preferred embodiment, the preserving is performed for 64-72 h.

In another preferred embodiment, a volume ratio of the tissue or cells (such as adipose tissue) to the preservation solution in the preserving is (1-2):(1-2); preferably (1-1.5):1, and more preferably 1:1.

### The Present Invention has the Following Main Advantages.

While ensuring a sterile environment in a transport and preservation process, the transport preservation solution of the present invention can prolong the transport and preservation time of an adipose sample at low temperature (2-8° C.) to 72 h or more without affecting the activity and quantity of stromal vascular fraction cells in the transport process, so that the safety and efficiency of transport and preservation of the adipose tissue are ensured.

The present invention is further illustrated below in combination with specific examples. It should be understood that these examples are used only to describe the present invention without limiting the scope of the present invention. Experimental methods without specific conditions in the following examples are usually used in accordance with conventional conditions, such as conditions described in Molecular Cloning: Laboratory Manual disclosed by Sambrook et al. (New York: Cold Spring Harbor Laboratory Press, 1989), or in accordance with conditions recommended by manufacturers. Unless otherwise specified, percentages and parts are calculated by weight.

### Reagents

DMEM, high glucose and phenol red-free (manufacturer: GIBCO; item number: 31053-028) were used.

DMEM/F-12, HEPES and phenol red-free (manufacturer: Life; item number: 11039-021) were used.

### Example 1

A formulation of a sample transport preservation solution is shown in Table 3.

TABLE 3

| Reagent name | Raw material component | Content percentage (v/v) |
|---|---|---|
| Sample transport | DMEM, high glucose and phenol red-free | 80% |
| solution | DMEM/F-12, HEPES and phenol red-free | 18% |
| | Gentamicin sulfate | 100 ng/ml |
| | L-glutamine-200 mM (100X) | 2% |

A simple preparation process of the sample transport preservation solution includes:
(1) taking out the L-glutamine-200 mM (100×) from a refrigerator at −20° C. in advance, and placing the same in a refrigerator for melting at 2-8° C.;
(2) placing a centrifuge tube on a centrifuge tube rack, placing the centrifuge tube rack on a balance, adjusting the balance to zero, and weighing a corresponding amount of the gentamicin sulfate;
(3) sucking a corresponding volume of the DMEM, high glucose and phenol red-free into a reservoir bottle;
(4) sucking a corresponding volume of the DMEM/F-12, HEPES and phenol red-free into the reservoir bottle;
(5) sucking a corresponding volume of the glutamine-200 mM (100×) into the reservoir bottle to obtain a mixed solution; and
(6) adding a part of the mixed solution into the centrifuge tube containing gentamicin sulfate, performing blowing for complete dissolution, transferring the resulting solution into the reservoir bottle, tightening a bottle cap, shaking the bottle up and down for uniform mixing, and performing filtration with a bottle-top filter, followed by sub-packaging.

### Example 2

### Adipose Tissue Sample Preservation Time Comparison Test

A sample used in experimental research and grouping information are as follows. A cell number is as follows: ALAM0317 sample: adipose tissue.

Grouping is as follows:

Group A (control group): 75 ml of the adipose sample was preserved in the transport preservation solution of Example 1 (a volume of the preservation solution was 75 mL, and a ratio of the adipose to the transport preservation solution was 1:1) at 2-8° C. for 48 h;

Group B (experimental group): 15 ml of the adipose sample was preserved in the transport preservation solution of Example 1 (a volume of the preservation solution was 15 mL, and a ratio of the adipose to the transport preservation solution was 1:1) at 2-8° C. for 72 h;
the preservation was performed by simulating transport conditions for automobile transportation between Shanghai and Wuxi.

The preserved adipose samples in Group A and Group B were subjected to washing, digestion with collagenase, cell separation and filtration, extraction of SVF cells, and counting by a blood cell analyzer, respectively, according to standard operating procedures.

Counting results are as follows.

In Group A, an adipose volume is 75 mL, a cell suspension volume is 37 ml, and a counting result is 1.8×10⁹/L.

In Group B, an adipose volume is 15 mL, a cell suspension volume is 27 ml, and a counting result is 0.6×10⁹/L.

TABLE 4

| Group | SVF cell quantity/mL adipose |
|---|---|
| Group A | 8.88 × 10⁵ |
| Group B | 1.08 × 10⁶ |

According to the adipose in Group B, the extraction quantity of SVF cells is not reduced by the prolonged preservation time (72 h) (normally, the extraction quantity of SVF cells is about 5×10⁵-1.2×10⁶/ml adipose).

As can be seen from Table 4, the adipose tissue can be transported and preserved in the transport preservation solution of the present invention at 2-8° C. for 72 h without affecting the extraction of SVF cells, indicating that the transport and preservation time of the adipose sample is prolonged to 72 h or more in the present invention. Meanwhile, the cell activity is maintained, microbial contamination is controlled, great convenience is provided for safe and efficient transport and preservation of the adipose tissue, and an excellent effect is achieved.

All documents mentioned in the present invention are cited as references in the present application as if each document is cited separately as a reference. In addition, it should be understood that various alternations or modifications to the present invention can be made by a person skilled in the art after reading the foregoing disclosure of the present invention, and these equivalents also fall within the scope defined in the appended claims of the present application.

1. An adipose tissue transport preservation solution, comprising:
(a) 60-90 parts by weight of DMEM, high glucose and phenol red-free;
(b) 10-30 parts by weight of DMEM/F-12, HEPES and phenol red-free;
(c) 50-200 ng/mL of a bactericide or an antibiotic; and
(d) 2-10 mmol/L of glutamine (such as L-glutamine).

2. The transport preservation solution according to claim 1, wherein in the transport preservation solution, the components (a)-(d) account for 80-100 wt % of a total weight of the preservation solution, preferably 85-99 wt %, and more preferably 95-98.5 wt %.

3. The transport preservation solution according to claim 1, wherein the component (a) accounts for 70-85 parts by weight, preferably 75-82 parts by weight.

4. The transport preservation solution according to claim 1, wherein the component (b) accounts 15-25 parts by weight, preferably 18-22 parts by weight.

5. The transport preservation solution according to claim 1, wherein the concentration of the component (c) is 80-120 ng/mL, preferably 90-110 ng/mL, and more preferably 95-105 ng/mL.

6. The transport preservation solution according to claim 1, wherein the bactericide is gentamicin (such as gentamicin sulfate or a gentamicin sulfate injection).

7. A method for preserving adipose tissue in a transport process, comprising the following step:
preserving adipose tissue in the transport preservation solution according to claim 1 at 2-8° C.

8. The preserving method according to claim 7, wherein the preserving is performed for 0.1-84 h.

9. The preserving method according to claim 7, wherein a volume ratio of the adipose tissue to the transport preservation solution in the preserving is (1-2):(1-2); preferably (1-1.5):1.

10. A preparation method for the tissue transport preservation solution according to claim 1, comprising the following step: uniformly mixing the components (a), (b), (c), and (d) at a ratio to obtain the tissue transport preservation solution.
